(19) United States
(12) Patent Application Publication
(10) Pub. No.: US 2026/0080670 A1
(43) Pub. Date: Mar. 19, 2026

(54) SYSTEM AND METHOD FOR OBJECT THREAT DETECTION USING HYBRID ANALYSIS

(71) Applicant: Leidos Security Detection & Automation, Inc., Tewksbury, MA (US)

(72) Inventors: Nicholas E. Ortyl, III, Bedford, MA (US); Joseph Celi, Boca Raton, FL (US); Joseph B. Payton, Fredericksburg, VA (US); Samantha Palmer, Henrico, VA (US)

(21) Appl. No.: 18/890,446

(22) Filed: Sep. 19, 2024

(51) Int. Cl. G06V 10/82; G01V 5/22; G06N 3/0455; G06N 3/084; G06N 3/088

(52) U.S. Cl. CPC G06V 10/82; G01V 5/22; G06N 3/0455; G06N 3/084; G06N 3/088; G06V 2201/07

(57) ABSTRACT

Systems and methods for object threat detection are discussed. Techniques for performing a hybrid analysis threat assessment using both a first artificial intelligence model trained on known threats and a second artificial intelligence model trained to detect anomalies are described.

### BACKGROUND

In recent years, various types of screening techniques have been developed to assist in securing physical facilities. Non-contact screening is an important tool to detect the presence of contraband or hazardous items being carried by an individual entering a restricted area or transportation hub such as a secure building, an airport, or a train station. Various technologies have been used for non-contact screening of individuals and/or objects including x-ray and millimeter-wave imaging. Such technologies can be used to produce images that reveal hidden objects carried on a person or concealed within other objects that are not visible to plain sight.

The image results may be programmatically and/or manually analyzed to identify potential threats.

### BRIEF SUMMARY

Embodiments of the present invention provide an improved technique for object threat detection. More particularly, embodiments utilize a hybrid object threat detection technique that processes digital scan images of a person or an object using both a first artificial intelligence model trained to detect known threats and a second artificial intelligence model trained to detect anomalies. The use of such a hybrid approach enables detection of both known and unknown threats.

In one embodiment a method for performing object threat detection using a hybrid analysis includes scanning an individual with a scanner, the scanning producing multiple digital images. The method also includes processing the digital images using a first artificial intelligence model trained to detect known threats and processing the digital images using a second artificial intelligence model that is trained to detect anomalies and utilizes an autoencoder. The method further includes determining, based on the processing performed using both the first artificial intelligence model and the second artificial intelligence model, that the digital images includes at least one suspect image. The method also generates an alert regarding the suspect image.

In another embodiment a method for performing object threat detection using a hybrid analysis includes scanning an object with a scanner, the scanning producing multiple digital images. The method also includes processing the digital images using a first artificial intelligence model trained to detect known threats and processing the digital images using a second artificial intelligence model that is trained to detect anomalies and utilizes an autoencoder. The method further includes determining, based on the processing performed using both the first artificial intelligence model and the second artificial intelligence model, that the digital images includes at least one suspect image. The method also generates an alert regarding the suspect image.

In an embodiment, a system for object threat detection includes a body scanner configured to scan an individual, the scan producing digital images. The system also includes one or more processors configured to execute instructions to process the digital images using a first artificial intelligence model trained to detect known threats and process the digital images using a second artificial intelligence model that is trained to detect anomalies and utilizes an autoencoder. The processors are further configured to execute instructions to determine based on the processing performed using both the first artificial intelligence model and the second artificial intelligence model, that the digital images include at least one suspect image, and to generate an alert regarding the suspect image. The system additionally includes a display device configured to display the alert.

In another embodiment, a system for object threat detection includes an object scanner configured to scan an individual, the scan producing digital images. The system also includes one or more processors configured to execute instructions to process the digital images using a first artificial intelligence model trained to detect known threats and process the digital images using a second artificial intelligence model that is trained to detect anomalies and utilizes an autoencoder. The processors are further configured to execute instructions to determine based on the processing performed using both the first artificial intelligence model and the second artificial intelligence model, that the digital images include at least one suspect image, and to generate an alert regarding the suspect image. The system additionally includes a display device configured to display the alert.

### BRIEF DESCRIPTION OF DRAWINGS

The accompanying drawings, which are incorporated in and constitute a part of this specification, illustrate one or more embodiments of the invention and, together with the description, help to explain the invention. In the drawings:

FIG. 1 depicts a process flow for an object threat detection system using a hybrid analysis in an exemplary embodiment;

FIG. 2 depicts operation of an autoencoder encoding an image to a latent space representation and its subsequent reconstruction;

FIG. 3 illustrates the results of performing a hybrid analysis with an exemplary model architecture in an embodiment;

FIG. 4 depicts a process flow for utilizing a fusion layer in an exemplary embodiment;

FIG. 5A schematically illustrates an environment including a body scanner suitable for use in an exemplary embodiment;

FIG. 5B schematically illustrates an environment including an object scanner suitable for use in an exemplary embodiment;

FIG. 6A depicts a sequence of steps for hybrid processing a scan of an individual in an exemplary embodiment;

FIG. 6B depicts a sequence of steps for hybrid processing a scan of an object in an exemplary embodiment;

FIG. 7 depicts an exemplary whole body scanner suitable for use in an exemplary embodiment; and

FIG. 8 depicts an exemplary object scanner suitable for use in an exemplary embodiment.

### DETAILED DESCRIPTION

Described in detail herein are methods, mediums, and systems for object threat detection using a hybrid analysis technique. The hybrid analysis technique described herein may be used in a variety of settings including, without limitation, airport screening, correctional institutions, mines and datacenters.

Embodiments of the present invention address a prevalent issue that exists across numerous object detection systems, how to adapt threat detection capabilities as threat objects rapidly evolve. Typically, many object threat detection systems are designed to address specific tasks or use cases, and they are built, tested, and evaluated based on the information and data available at that time to detect known threats. For example, some deep learning-based threat detection systems are trained with data that includes examples of each threat class the system needs to identify. At runtime, when the system encounters a threat not represented in the training set, one of two outcomes typically occurs: (1) the threat is misclassified and/or (2) the threat goes unnoticed. Once deployed, as conditions in the environment change or new threats emerge, the system's effectiveness often diminishes and/or requires the system to be re-trained in view of newly discovered threats.

For example, Transportation Security Administration (TSA) in the United States and the European Civil Aviation Conference (ECAC) in Europe approve algorithms that are designed to meet stringent security and privacy standards specific to their regions, ensuring consistent and reliable performance in regulated environments. Integrating ECAC considerations further emphasizes the importance of regulatory compliance, privacy protection, and standardized threat detection in European contexts. The artificial intelligence (AI) models used in the field are first trained on large datasets consistent with these privacy and security requirements that provide examples of these known threats. However, because of the stringent regulatory requirements from the governing bodies, newly identified threats frequently will require the model to be re-trained on new datasets that meet the privacy and security requirements, a process that can take months and result in a period of time between the time the type of new threat is identified and the completion of training/re-training of the AI model to identify the threat. During this period of time in which the model is being re-trained, the new type of threat may go undetected by the deployed model.

Another type of algorithm that may be employed to detect objects constituting a threat is an anomaly detection algorithm. Rather than being directed to a known threat, anomaly detection algorithms are AI models trained to identify unusual or suspicious objects by detecting deviations from what is considered normal or ‘clear’. Anomaly detection algorithms provide flexibility and broad applicability, identifying unconventional or new threats. These algorithms are versatile, used across various fields, and are not limited to security. Anomaly detection algorithms and regulatory approved algorithms can be distinguished with regards to scope, design, regulatory compliance, and operational parameters.

Embodiments of the present invention perform a hybrid analysis of scanned images of individuals or objects to detect hidden objects that may constitute a threat to facilities and/or people. More particularly, embodiments process captured images of individual or objects using both a first AI model trained on known threats and a second AI model trained to detect anomalies. As previously noted, the dual processing of acquired images improves the odds of detecting objects that represent newly identified types of threats for which the first model has yet to be trained. This dual processing approach is also beneficial in situations where there is a limited availability of labeled training data for the type of new threat to train the first AI model. The hybrid analysis technique described herein may also be particularly suitable to situations where the threat environment is subject to rapid change.

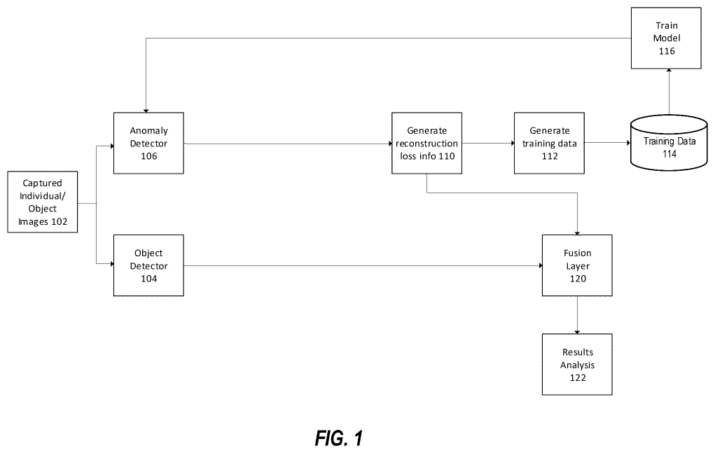

In one or more embodiments, threat detection systems designed to identify known threats are enhanced through the use of a hybrid analysis performed using a second AI model trained to detect anomalies. FIG. 1 depicts a process flow for an object threat detection system using a hybrid analysis in an exemplary embodiment. The method begins when an individual/object is scanned by a scanner, the scanning capturing a group of digital images 102 of a person or object of interest. The digital images 102 are processed using both an object detector 104 and an anomaly detector 106.

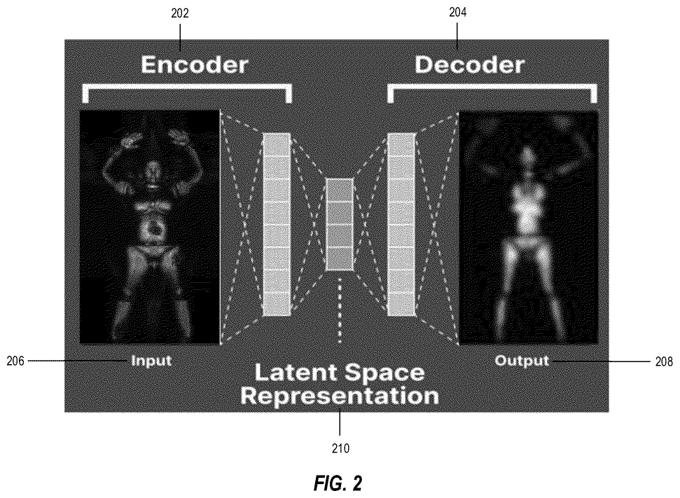

In one or more embodiments, object detector 104 is an AI model trained on images containing known threats such as specific types of weapons or explosives to identify those threats and anomaly detector 106 is an AI model trained in an unsupervised manner on normal “clean” images of objects/individuals that do not represent threats. For example, anomaly detector 106 may include a type of autoencoder such as, but not limited to, a convolutional autoencoder (CAE), a variational autoencoder (VAE), an adversarial autoencoder(AAE) or a Vector Quantized Variational autoencoder (VQ-VAE). Autoencoders are specialized neural networks designed for unsupervised learning, aimed primarily at reconstructing input data while identifying potential anomalies. FIG. 2 depicts operation of an autoencoder encoding an image to a latent space representation and its subsequent reconstruction. The autoencoder may be an autoencoder trained in an unsupervised manner that includes an encoder 202 and a decoder 204. The encoder 202 compresses the input images 206 into a bottleneck/lower-dimensional latent space representation 210, effectively learning a compact representation of the data that focuses on the key features of the input. Subsequently, the decoder 204 attempts to reconstruct the input images 206 from this compressed latent space representation 210 back to their original form and produces output 208. The quality of this reconstruction is measured using a loss function (such as mean squared error or mean absolute error) between the original and the reconstructed image.

Regions of the image that exhibit high reconstruction loss are indicative of anomalies, as they diverge from what the model has learned to consider ‘normal’. The loss between the original and reconstructed data may be backpropagated to adjust the model weights, making the model highly efficient over time, resulting in minimal loss between the original and reconstructed images.

In some embodiments, the anomaly detector 106 may include a Variational Autoencoder (VAE). A VAE extends the capabilities of traditional autoencoders by introducing a probabilistic framework for encoding and decoding data. Unlike standard autoencoders, which produce a singular latent point in the feature space, VAEs generate a distribution over the latent space for each input. The encoder 202 part of a VAE outputs not just a compressed representation of the input image 206, but also the parameters of a probability distribution, typically Gaussian, associated with the latent space. The decoder 204 then samples from this distribution to reconstruct the original image. This stochasticity allows VAEs to better model complex data distributions and enhances their ability to generalize. To quantify the quality of the reconstruction, VAEs employ a unique loss function that combines both reconstruction loss info and a regularization term, which ensures that the learned latent space approximates the desired prior distribution. In the context of anomaly detection, regions of the image where the VAE struggles to accurately reconstruct the input are likely to be indicative of anomalous features.

In some embodiments, the anomaly detector 106 may include an Adversarial Autoencoder (AAE). AAEs combine the principles of traditional autoencoders and Generative Adversarial Networks (GANs) to create a more robust and versatile model for anomaly detection. Structurally, an AAE consists of an encoder 202, a decoder 204, and an adversarial network. The encoder 202 compresses the input image 206 into a latent space representation 210, similar to traditional autoencoders. The decoder 204 aims to reconstruct the input 206 from this latent space. What sets AAEs apart is the adversarial network that tries to distinguish between the model's latent space representation 210 and a pre-defined or learned distribution, usually a Gaussian distribution. This adversarial process forces the encoder 202 to generate latent variables that not only enable accurate data reconstruction but also closely adhere to the desired distribution. This dual objective enhances the model's ability to identify anomalous data points effectively. In anomaly detection tasks, AAEs can flag regions in images that deviate significantly from the learned distribution in the latent space, thus providing a more nuanced and robust means for detecting anomalies.

In an embodiment, anomaly detector 106 may be an AI model trained using a set of ‘normal’ condition images. For example, for use cases where the anomaly detector will be examining scans of individuals, the anomaly detector may be trained on a set of images of individuals in different shapes and sizes (for example individuals with different body mass indexes (BMIs)) that are considered “clean” in that the images of the individuals do not contain any sort of threat. In some embodiments, the anomaly detector 106 operates before the object detector 104 in the runtime pipeline. In other embodiments, the anomaly detector 106 operates after or in parallel with the object detector 104 in the runtime pipeline.

At runtime, a reconstruction loss 110 exceeding a specific threshold indicates a potential anomaly. The reconstruction loss info 110 from anomaly detector 106 can be combined with the results of object detector 104 to create a fusion layer 120 combining results from both the anomaly detector 106 and object detector 104. Fusion layer 120 may be processed to produce a results analysis 122. In some embodiments, the results analysis may include the generation of an alert and/or the display of an image containing graphical indicators of suspect areas of an individual needing further examination.

A number of different model architectures may be employed to determine reconstruction loss. In a first approach, both the reflectivity and depth channels are trained independently and then the combined loss is used for anomaly detection. The reflectivity channel contains scaled values that represent the surface imaged materials'reflection electromagnetic waves, while the depth channel provides a value representing relative distances from the detector to the scanned material.

In a second approach, the reflectivity and depth channels are both trained together with a combined output and the combined loss is used for anomaly detection. In other words, the latent space will include features from both channels. The overall loss is comprised of both the reflective channel loss added to the depth channel loss. It should be noted that in some experiments implementing the first and second approach, the use of the depth channel helped with threats outside the body but added a significant amount of noise to the final result.

In a third approach, the reflectivity and depth channel are used as input but only the reflectivity channel is output. The model is trained to minimize the loss of this output channel against the original reflectivity channel. This approach allows the depth channel to contribute to the reconstruction of the reflectivity channel. Loss is computed only at the reflectivity channel. The advantage of this approach is that the depth information can be used to add features to the latent space to better reconstruct the reflectivity reconstruction. In experiments, this third approach was able to find threats both outside and within the frame of a body and generated little to no noise at a threshold value of 100.

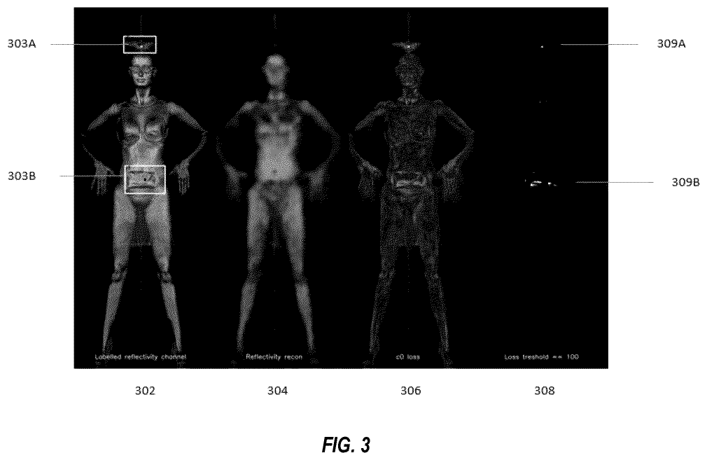

FIG. 3 schematically illustrates the results of performing a hybrid analysis with an exemplary model architecture in an embodiment. More particularly, FIG. 3 depicts the results of usage of the third model architecture discussed above where the reflectivity and depth channel are used as input but only the reflectivity channel is output. As illustrated, the initial reflectivity image data 302 includes two possible threats 303A, 303B that have been labeled for explanatory purposes via bounding boxes. The next image 304 shows the initial reconstruction of the image which includes information from the depth channel. The image 306, second from the right, depicts the reflectivity loss computed for the reflectivity channel and the final image 308, with the confidence threshold increased to 100%, shows little to no noise (trace amounts around the neck area) and the two threats 309A, 309B. With the results of this scan the system could programmatically alert security personnel on site to perform an inspection of the two areas 309A, 309B on the individual.

In some embodiments, a 2D autoencoder may be used. In other embodiments a 3D autoencoder may be employed.

In some embodiments, a batch size may be adjusted to optimize the system. A batch size is a hyperparameter that determines the number of samples used in one forward and backward pass of the neural network during training. It has several effects on the training process and the model's performance. For example, some of the main effects of different batch sizes include:
1) Computational efficiency: Using a larger batch size allows for better use of hardware (such as GPUs), as it can process multiple samples in parallel, improving computational efficiency. However, this comes at the cost of increased memory requirements, as the gradients and intermediate activations for all samples in the batch need to be stored.
2) Convergence speed: Larger batch sizes generally result in a faster convergence per epoch, as the model processes more samples in each update step. However, this advantage diminishes with very large batch sizes, as the time required to perform each weight update also increases.
3) Generalization: Smaller batch sizes can lead to better generalization, as they introduce more noise into the gradient updates. This noise can help the model escape local minima and find better solutions. Larger batch sizes provide more accurate gradient estimates but may converge to less optimal solutions.
4) Stability: Smaller batch sizes can lead to more unstable training, as the weight updates are more influenced by individual samples. Larger batch sizes result in smoother training as the gradient estimates become more consistent across updates.
5) Memory requirements: Larger batch sizes require more memory to store the intermediate values during training, which can be a limitation on the hardware being used. Smaller batch sizes use less memory, allowing for more complex models or larger input sizes.

There is a trade-off between the various effects of batch size, and the optimal value depends on the problem, dataset, model architecture, and available hardware. In some embodiments, the anomaly detector described herein may use a batch size of 8 or larger. For example in some preferred embodiments, the batch size may be 64.

In some embodiments, the anomaly detector identifies regions of high reconstruction loss info 110 to alert a human operator to potential threats, enabling operator-assisted threat detection. For example,, the anomaly detector may generate a bounding box around high reconstruction loss info 110 to direct attention to potential threats. In some embodiments, additional normal conditions can be added to images used to train the anomaly detector 106 for continuous training, making the detector more robust to new, non-threatening conditions not represented in the training data 114. In such a case, the additional normal conditions are used to generate training data 112 and the resulting training data 114 can be utilized to train model 116, which updates anomaly detector 106 by refreshing the model. In some embodiments, a human operator can adjust confidence intervals (0% to 100%) via user interface controls provided by the system and specify the physical size of threat items to tailor the results analysis 122 to fit the risk tolerance of the environment.

In one embodiment, the hybrid analysis system provides a user-adjustable sensitivity slider in a user interface (UI), which allows operators to control the confidence interval for detecting anomalies. This slider inversely correlates with the confidence score generated by the AD model. The model determines this confidence score by comparing the original image to its reconstructed version, calculating the reconstruction loss for each region. Regions with losses that are several standard deviations above the mean are flagged as potential anomalies. The more significant the deviation, the higher the confidence score assigned to that anomaly. As the user increases the sensitivity via the slider, the system lowers the confidence threshold, allowing the detection of anomalies with lower confidence scores. This results in more anomalies being flagged, including those that the model considers less certain. Conversely, decreasing the sensitivity raises the confidence threshold, meaning only anomalies with higher confidence scores are flagged, thus reducing the number of false positives. This dynamic interaction between the user-defined confidence interval and the model-generated confidence score ensures that the system can be tailored to fit the specific risk tolerance of the environment, balancing the need for detection accuracy with operational efficiency.

In one embodiment, the hybrid analysis system described herein may allow a user to set different confidence levels and object size thresholds for different areas/zones of the body. For example, a user may be provided with the opportunity via a user interface on a display device to set one confidence level and/or object size threshold for the head/neck region and a second different confidence level and/or object size threshold for the legs and feet. It will be appreciated that zones with this approach may include any number of regions identified by the system in addition to, or in place of, head/neck and legs/feet. For example, exemplary regions might include, but are not limited to, head to breast and breast to under groin.

In one or more embodiments, the anomaly detector can serve as an early attention mechanism for a computer vision pipeline. By identifying anomalies (areas of high reconstruction loss info), the anomaly detector can direct attention to specific parts of an image or video frame, enhancing the overall detection and analysis process.

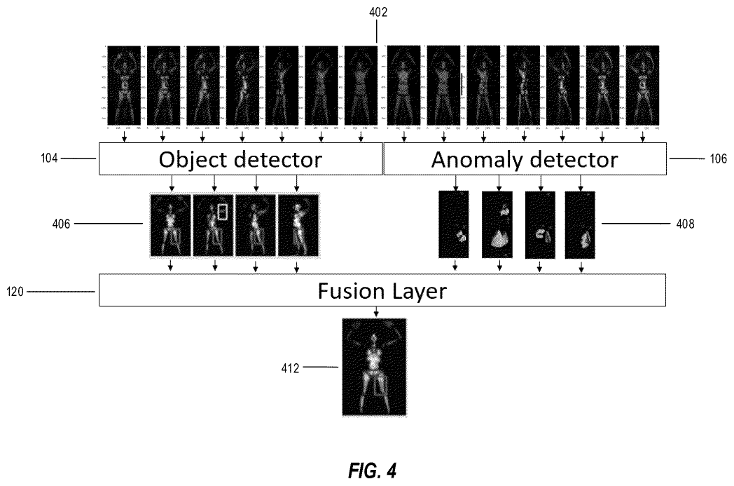

FIG. 4 depicts a process flow for utilizing a fusion layer in an exemplary embodiment The original set of captured images 402, are processed by both the object detector 104 and anomaly detector 106. Object detector 104 detects known threats it has been trained to detect and flags such threats (such as through the use of bounding boxes) in final output 406. In one or more embodiments, output 408 from anomaly detector 106 visibly identifies areas of high reconstruction loss to direct attention to specific parts of an image for threat detection purposes. Fusion layer 120 combines information from both detectors in final output 412 for analysis thus enabling detection of unusual objects or threats individually missed by the object detector 104 algorithm or anomaly detector 106 algorithm. In one embodiment, a bounding box or other indicator may be used to visually identify one or more locations in the reconstructed output image 412 that indicates a suspect object.

In embodiments, multiple views of a subject are captured and analyzed individually by the anomaly detector, with each view providing a unique perspective. The anomaly detector processes each view, identifying potential anomalies based on the reconstruction loss and assigning a confidence score to each detected anomaly. The code of the fusion layer in the hybrid analysis system then plays a critical role in synthesizing the results from these various views. The fusion layer correlates the anomalies detected across the different views by considering their spatial locations and confidence scores. By aligning these anomalies across the different perspectives, the fusion layer can determine whether multiple anomalies correspond to the same potential issue or if they are isolated incidents. This correlation process enhances the system's ability to accurately identify and localize anomalies by integrating data from all views. The final result is a more reliable and comprehensive detection output, as the fusion layer consolidates the information from multiple perspectives, ensuring that the anomalies identified are consistent and significant across the different views.

In one or more embodiments, fusion layer 120 identifies items not included in the training dataset of object detector 104 and can help identify new, unforeseen types of prohibited items. As new threats emerge, anomaly detector 106 remains effective without needing retraining and is especially valuable for objects that are not yet part of the object detector 104 algorithm's learned patterns. In one or more embodiments, fusion layer 120 reduces overreliance on training data and lessens dependency on constantly updated training datasets. This hybrid approach described herein using the first and second AI models enhances detection capabilities without the need for frequent model retraining and adds an extra layer of security by identifying anomalies that may indicate novel threats.

When the object detector runs in parallel with the anomaly detector, both the size of the object detected, and the confidence threshold can be adjusted for each. This allows the end user to balance detection rates against false alarm rates. Higher thresholds reduce false alarm rates but may also miss subtle anomalies. In contrast, lower thresholds increase sensitivity to anomalies at the cost of more false alarms. For instance, in an airport security setting, items smaller than 20 mm square may be excluded (e.g., body piercings), while in a diamond mine or correctional facility, items as small as 2 mm square may be of interest. Smaller objects and lower confidence intervals typically result in higher false alarm rates, leading to secondary screening procedures such as pat-downs or detailed bag searches.

In some embodiments, augmentations may be used to expand the dataset used to train the anomaly detector so that it will learn how to remove uncommon artifacts, distortions or anything not normally seen in the clear scans. In one embodiment, Gaussian noise is added to simulate possible artifacts or imperfections in the scanning process. This can help the model become more robust to noise in real-world data. In other embodiments, precision reduction, random shape cutouts, horizontal flips, Gaussian blur and/or face blur, may be added to the training data to improve performance. Precision reduction reduces the precision of the input data to simulate various levels of image quality degradation, thereby enabling the model to maintain effectiveness under different resolutions and image qualities. Random shape cutouts randomly remove portions of the input images by applying cutouts of various shapes and sizes to facilitate the model's ability to identify objects even when parts of the image are missing or occluded. Horizontal flips flip the images horizontally to increase the diversity of the training data by simulating different orientations, thereby enhancing the model's ability to recognize objects from different angles. Gaussian blur is applied to the input images to simulate out of focus conditions, thereby ensuring the model's robustness to varying image sharpness. Face blur in the input images directs the autoencoder's focus towards detecting objects and anomalies rather than facial features as facial features are not normally being pertinent to threat detection. In other embodiments, small translations can be applied to the images during training if the position of the person in the scanner may vary slightly. This will help the model become more robust to slight shifts in position by individuals during scanning. In another embodiment, random intensity shifts or contrast adjustments can be applied to the images during training. This accounts for the intensity of the images varying due to different factors, such as scanner calibration or patient-specific characteristics. In a further embodiment, small elastic deformations may be applied to the images during training to assist the model in becoming more robust to slight variations in body shape and pose. In another embodiment Quantization noise may be applied to the images during training so that models will be more resilient to the effects of such noise.

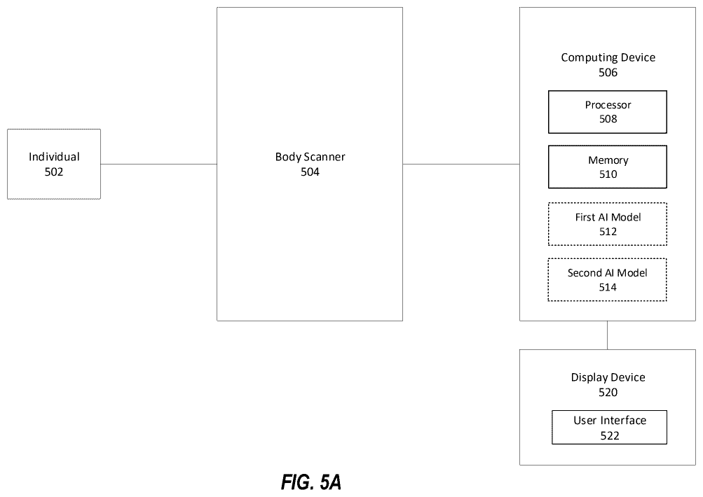

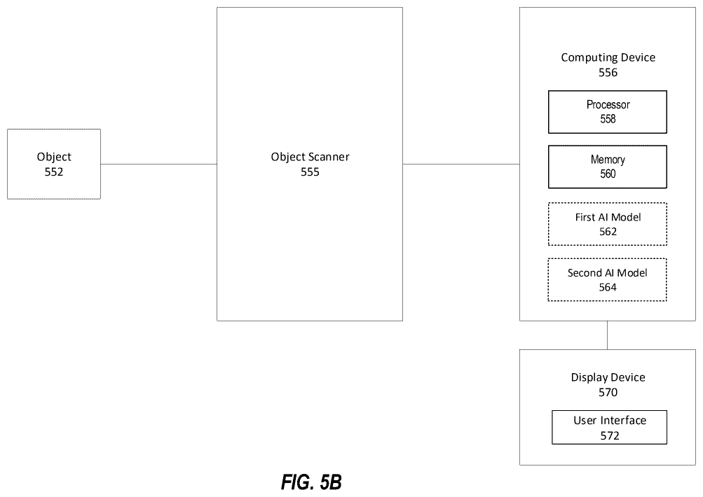

FIG. 5A schematically illustrates an environment including a body scanner suitable for use in an exemplary embodiment. An exemplary threat detection system 500 includes a body scanner 504 to scan an individual 502 and a computing device 506. Computing device 506 includes one or more processors 508 configured to or programmed to execute instructions and memory 510 holding computer executable instructions. Processor 508 may take several forms including without limitation that of a central processing unit or graphical processing unit. Computing device 506 may execute instructions to perform at least some of the operations described herein. In some embodiments, computing device 506 may be integrated into body scanner 504 and in others it may communicate with the body scanner from a distance including over a network(not shown). Computing device 506 may be but is not limited to a server, laptop, PC or embedded device. As noted, in some embodiments, computing device 506 may be integrated into and form part of body scanner 504. In one embodiment, body scanner 504 is a millimeter wave scanner. In an exemplary embodiment, body scanner 504 may be a ProVision®3 from Leidos™. Computing device 506 is configured to execute first AI Model 512 trained to detect known threats and second AI model 514 trained to detect anomalies. Threat detection system 500 also includes display device 520 and user interface 522. In some embodiments, display device may display generated alerts following the processing of images as described herein. In some embodiments, user interface 522 may be used by a user to adjust confidence intervals of the anomaly detector and other parameters of the threat detection system as described herein.

FIG. 5B schematically illustrates an environment including an object scanner suitable for use in an exemplary embodiment. An exemplary threat detection system 550 includes an object scanner 554 to scan an object 552 and a computing device 556. Computing device 556 includes one or more processors 558 configured to or programmed to execute instructions and memory 510 holding computer executable instructions. Processor 558 may take several forms including without limitation that of a central processing unit or graphical processing unit. Computing device 556 may execute instructions to perform at least some of the operations described herein. In some embodiments, computing device 556 may be integrated into object scanner 554 and in others it may communicate with the object scanner from a distance including over a network (not shown). Computing device 556 may be but is not limited to a server, laptop, PC or embedded device. As noted, in some embodiments, computing device 556 may be integrated into and form part of object scanner 554. In one embodiment, object scanner 554 is configured to perform x-ray or CT scans. Computing device 556 is configured to execute first AI Model 562 trained to detect known threats and second AI model 564 trained to detect anomalies. Threat detection system 550 also includes display device 570 and user interface 572. In some embodiments, display device 570 may display generated alerts following the processing of images as described herein. In some embodiments, user interface 572 may be used by a user to adjust confidence intervals of the anomaly detector and other parameters of the threat detection system as described herein.

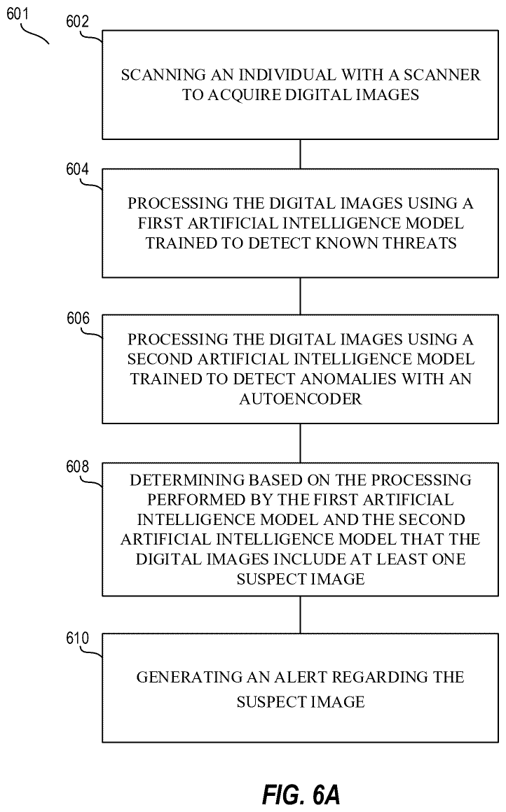

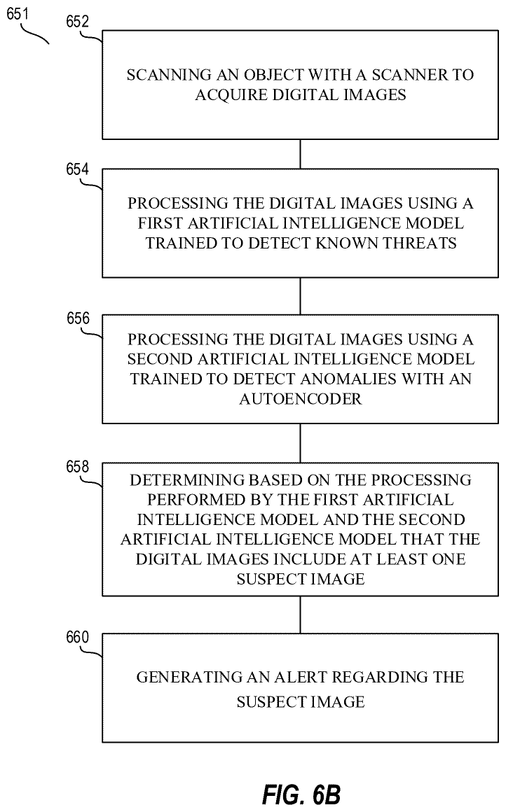

FIG. 6A depicts a sequence of steps for hybrid processing a scan of an individual in an exemplary embodiment At block 602, the method includes scanning an individual with a scanner to acquire digital images. At block 604, the method includes processing the digital images using a first artificial intelligence model trained to detect known threats. At block 606, the method includes processing the digital images using a second artificial intelligence model trained to detect anomalies with an autoencoder. At block 608, the method includes determining based on the results of processing the digital images by the first artificial intelligence model and the second artificial intelligence model that the digital images include at least one suspect image. At block 610, the method includes generating an alert regarding the suspect image. The alert may take a number of forms including visual, audible and/or tactile alerts. In some embodiments, the alerts may be sent to on site security personnel to conduct an investigation of the individual.

FIG. 6B depicts a sequence of steps for hybrid processing a scan of an object in an exemplary embodiment At block 652, the method includes scanning an object with a scanner to acquire digital images. At block 654, the method includes processing the digital images using a first artificial intelligence model trained to detect known threats. At block 656, the method includes processing the digital images using a second artificial intelligence model trained to detect anomalies with an autoencoder. At block 658, the method includes determining, based on the results of processing the digital images by the first artificial intelligence model and the second artificial intelligence model, that the digital images include at least one suspect image. At block 660, the method includes generating an alert regarding the suspect image. The alert may take a number of forms including visual, audible and/or tactile alerts. In some embodiments, the alerts may be sent to on site security personnel to conduct an investigation of the object.

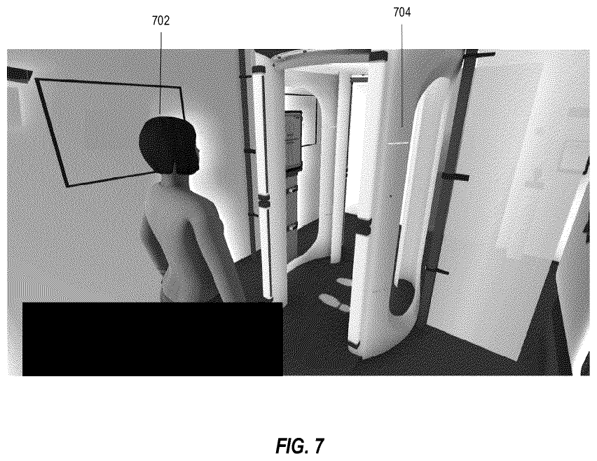

FIG. 7 depicts an exemplary whole body scanner suitable for use in an exemplary embodiment. Whole body scanner 704 uses millimeter wave technology to examine individual 702 for hidden unauthorized objects. In some embodiments, with some types of whole body scanners, individual 702 enters the imaging chamber in a forward direction through the entrance and stands at or about a central point in the chamber. The central point can be indicated using instructional markings to aid the individual in understanding how to stand for purposes of scanning such as footprint markings. The individual turns in a direction orthogonal to an axis that connects the entrance and an exit of the chamber. In other words, the individual turns 90°, often to the right, to face a side direction. Once the individual is in a correct location within the imaging chamber, the individual assumes a scanning position, which is referred to as a ‘pose’.

An example of a pose is as follows: The individual places his or her hands over his or her head. Other poses are also possible, such as the individual standing naturally in a relaxed stance with his or her arms at his or her side or with hands placed on hips. Once the individual is in the scanning position (e.g., has assumed the pose), two imaging masts rotate around the individual on scan paths.

In some embodiments the imaging masts are connected in a “tuning fork” shaped configuration to a rigid central mount located in a roof of the chamber. Because the two imaging masts are rigidly connected, they both rotate in the same direction, e.g., clockwise or counter-clockwise, and maintain a constant spacing distance between them. The imaging masts include both transmitters and receivers. Each receiver is spatially associated with a transmitter such as by being placed in close proximity so as to form or act as a single point transmitter/receiver. In operation, the transmitters sequentially transmit electromagnetic radiation at a regular rate (e.g. 256 pulses per second) one at a time that is reflected or scattered from the object, and the reflected or scattered electromagnetic radiation is received by two of the respective receivers. A computing device receives signals from the receivers and reconstructs an image of the object using a monostatic reconstruction technique. Hidden objects or contraband may be visible on the image because the density or other material properties of the hidden object differ from organic tissue and create different scattering or reflection properties that are visible as contrasting features or areas on an image.

Based on a received signal a computing device can analyze the strength of a returned pulse, the time it took to travel to the object and back, and the phase or Doppler shift of the pulse and determine if an object has entered the body scanner. The Doppler effect of the electromagnetic radiation can be used to detect when an object enters, exits or is within the scanner, such as an object moving through the scanner. The entrance of the object into the body scanner may be expected or not. For example, the body scanner can determine when an individual has entered the body scanner and initiate a body scanning process. As another example, in a case where an individual is waiting to enter the body scanner, but is in possession of an object that they do not want to enter the body scanner with, the individual may attempt to throw the object through the scanner to try and avoid detection of the object. In such a case, whole body scanner 704 as taught herein is able to detect the object entered the scanner and take an action to alert, for example, security personnel.

In some embodiments, whole body scanner 704 is also equipped with cameras and a display to correct or guide an orientation or a pose or both of an object in any of the systems described herein. Embodiments provide real-time feedback to individual 702 for accurately positioning the individual with a scanning system. According to some embodiments, whole body scanner 704 includes or communicates with a processing system/computing device that can receive information from the cameras about the pose of an individual. The information can be images or information about the images. For example, the information can be images of an individual or information about the location of a body joint of an individual. Whole body scanner 704 may initiate a scan of the body of the individual responsive to determining that the pose of the individual satisfies a target pose. For example, once the individual achieves a suitable pose, a scan may be performed. As used herein, pose refers to the position or orientation or both of the individual to be scanned and can be the arrangement of the arms and legs, etc. of the individual. In some embodiments, the camera system may also be used for threat identification, for example by detecting an object, such as, but not limited to, a USB hidden between an individual's fingers.

It should be appreciated that the whole body scanner 704 depicted and discussed with respect to FIG. 7 is but one example of a body scanner suitable for use with embodiments and the present invention is not limited to either the description or depictions of FIG. 7.

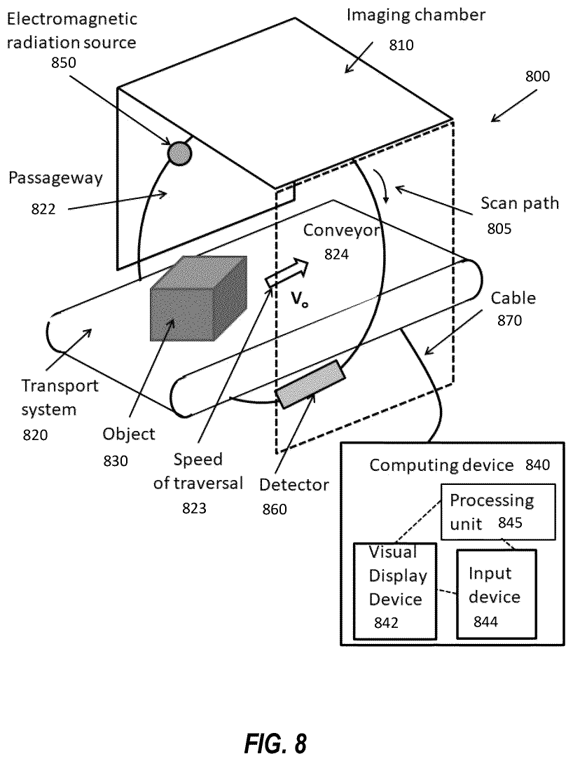

FIG. 8 depicts an exemplary object scanner suitable for use in an exemplary embodiment. FIG. 8 illustrates an exemplary object scanner 800 for generating an x-ray image of at least a portion of an object 830, according to one or more embodiments described herein. The object scanner 800 includes an imaging chamber 810, a transport system 820 to transport an object 830, a computing device 800, an X-ray source 850, and a detector 860. The imaging chamber 810 encloses a tunnel 822. The computing device 840 can include an input device 844 and a processing unit 845 and can render an image and other interfaces on a visual display device 842. The computing device 840 including the processing unit 845 can be configured to exchange data, or instructions, or both data and instructions, with at least one of the other components of the object scanner 800 wirelessly or via one or more wires or cables 870.

The transport system 820 can be configured to transport the object 830 through at least a portion of the tunnel 822 of the imaging chamber 810. In accordance with various embodiments, the transport system 820 can include an object transport mechanism such as, but not limited to, a conveyer belt 824, a series of rollers, or a cable that can couple to and pull an object 830 into the imaging chamber 810. The transport system 820 can be configured to transfer the object 830 into the tunnel 822 of the imaging chamber 810 at a range of speeds. For example, the transport system 820 may operate to transport the object 830 at speeds between about 5.0 cm/s and about 40 cm/s. In some embodiments, the transport system 820 can operate to transport the object 830 at speeds up to about 75 cm/s. Although some examples herein are described relative to specific values of speed of transport, it should be understood that there is no limitation on speed of transport applicable to the embodiments described herein.

The transport system 820 may transfer an object 830 at more than one speed and may also stop or move in reverse. The speed of the transport system 820 can be varied by the computing device 840 or by use of a manual switch or dial. The transport system 820 can contain a controller with a central processing unit (for example, a microcontroller) that is able to receive instruction from the computing device 840 and adjust or maintain a speed of the transport system 820 in accordance with said instructions. The object scanner 800 and the transport system 820 can transport the object 830 at a speed of traversal (V₀) 823 relative to the scan path 805 of the conical beam of the X-ray source 850. It should be appreciated that the object scanner 800 is one of many different possible systems for scanning objects (e.g., individuals, items, etc.). In some embodiments, the object scanner 800 is a gantry style x-ray scanner for scanning luggage, bags, shoes, packages and other objects, in some embodiments the object scanner 800 is a millimeter wave scanner and in some embodiments the object scanner 800 is an x-ray scanner having one or more fixed electromagnetic radiation sources and one or more detector arrays. According to one or more embodiments described herein, the object scanner 800 can implement an inference engine to detect certain items, such as contraband, hazardous materials, and/or the like including combinations and/or multiples thereof.

It should be appreciated that the object scanner 800 depicted and discussed with respect to FIG. 8 is but one example of an object scanner suitable for use with embodiments and the present invention is not limited to either the description or depictions of FIG. 8.

Portions or all of the embodiments of the present invention may be provided as one or more computer-readable programs or code embodied on or in one or more non-transitory mediums. The mediums may be, but are not limited to a hard disk, a compact disc, a digital versatile disc, ROM, PROM, EPROM, EEPROM, Flash memory, a RAM, or a magnetic tape. In general, the computer-readable programs or code may be implemented in any computing language.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

The foregoing description of example embodiments of the invention provides illustration and description, but is not intended to be exhaustive or to limit the invention to the precise form disclosed. Modifications and variations are possible in light of the above teachings or may be acquired from practice of the invention. For example, while a series of acts has been described, the order of the acts may be modified in other implementations consistent with the principles of the invention. Further, non-dependent acts may be performed in parallel.

We claim:

1. A computing device-implemented method for object threat detection, the computing device including at least one processor, the method comprising:
scanning the body of an individual with a body scanner, the scanning producing a plurality of digital images;
processing the plurality of digital images using a first artificial intelligence model trained to detect known threats;
processing the plurality of digital images using a second artificial intelligence model that is trained to detect anomalies and utilizes an autoencoder;
determining based on the processing performed using both the first artificial intelligence model and the second artificial intelligence model, that the plurality of digital images includes at least one suspect image; and
generating an alert regarding the suspect image.

2. The method of claim 1, wherein the alert includes an image of the individual with a graphical indicator identifying an area of concern.

3. The method of claim 1, further comprising:
training the second artificial intelligence model in an unsupervised manner on a plurality of normal condition images of individuals having a range of Body Mass Indexes.

4. The method of claim 1, further comprising:
using augmentations added to the normal condition images to train the anomaly detector.

5. The method of claim 4 wherein the augmentations include one or more of Gaussian noise, precision reduction, random shape cutouts, horizontal flips, Gaussian blur and face blur.

6. The method of claim 1, further comprising:
adjusting one or more of a confidence threshold and a size threshold of objects to be detected for either or both of the first artificial intelligence model and the second artificial intelligence model via a user interface.

7. The method of claim 1, further comprising:
adjusting one or more of a confidence threshold and a size threshold of objects to be detected for different zones of the individual's body via a user interface for either or both of the first artificial intelligence model and the second artificial intelligence model.

8. The method of claim 1, wherein the body scanner is a millimeter wave scanner.

9. The method of claim 1 wherein the autoencoder is a convolutional autoencoder, a variational autoencoder or an adversarial autoencoder.

10. The method of claim 1, wherein the autoencoder includes an encoder and decoder that is trained in an unsupervised manner and optimized to reduce reconstruction loss.

11. The method of claim 10, wherein the encoder compresses the original image into a latent space representation, the decoder reconstructs the image from the latent space representation, and the loss between the original and reconstructed images is backpropagated to adjust the model weights.

12. A computing device-implemented method for object threat detection, the computing device including at least one processor, the method comprising:
scanning an object with an object scanner, the scanning producing a plurality of digital images;
processing the plurality of digital images using a first artificial intelligence model trained to detect known threats;
processing the plurality of digital images using a second artificial intelligence model that is trained to detect anomalies and utilizes an autoencoder;
determining based on the processing performed using both the first artificial intelligence model and the second artificial intelligence model, that the plurality of digital images includes at least one suspect image; and
generating an alert regarding the suspect image.

13. The method of claim 12, wherein the alert includes an image of the object with a graphical indicator identifying an area of concern.

14. The method of claim 12, further comprising:
training the second artificial intelligence model in an unsupervised manner on a plurality of normal condition images of objects.

15. The method of claim 12, further comprising:
using augmentations added to the normal condition images to train the anomaly detector.

16. The method of claim 15 wherein the augmentations include one or more of Gaussian noise, precision reduction, random shape cutouts, horizontal flips and Gaussian blur.

17. The method of claim 12, further comprising:
adjusting a confidence threshold for both the first artificial intelligence model and the second artificial intelligence model via a user interface to balance detection rates against false alarm rates.

18. The method of claim 12, further comprising:
adjusting a size threshold of objects to be detected via a user interface.

19. The method of claim 12, wherein the object scanner is a CT scanner or x-ray scanner.

20. The method of claim 12 wherein the autoencoder is a convolutional autoencoder, a variational autoencoder or an adversarial autoencoder.

21. The method of claim 12, wherein the autoencoder includes an encoder and decoder that is trained in an unsupervised manner and optimized to reduce reconstruction loss.

22. The method of claim 21, wherein the encoder compresses the original image into a latent space representation, the decoder reconstructs the image from the latent space representation, and the loss between the original and reconstructed images is backpropagated to adjust the model weights.

23. A non-transitory medium holding computing device-executable instructions for performing threat detection, the instructions when executed causing at least one computing device equipped with a processor to:
receive and process a plurality of digital images taken of the body of an individual scanned using a body scanner, the processing using a first artificial intelligence model trained to detect known threats;
process the plurality of digital images using a second artificial intelligence model that is trained to detect anomalies and utilizes an autoencoder;
determine based on the processing performed using both the first artificial intelligence model and the second artificial intelligence model, that the plurality of digital images includes at least one suspect image; and
generate an alert regarding the suspect image.

24. The medium of claim 23, wherein the alert includes an image of the individual with a graphical indicator identifying an area of concern.

25. The medium of claim 23, wherein the instructions when executed further cause the at least one computing device to:
train the second artificial intelligence model in an unsupervised manner on a plurality of normal condition images of individuals having a range of Body Mass Indexes.

26. The medium of claim 25, wherein the instructions when executed further cause the at least one computing device to:
use augmentations added to the normal condition images to train the anomaly detector.

27. The method of claim 23, wherein the instructions when executed further cause the at least one computing device to:
adjust one or more of a confidence threshold and a size threshold of objects to be detected for either or both of the first artificial intelligence model and the second artificial intelligence model via a user interface.

28. The method of claim 23, wherein the instructions when executed further cause the at least one computing device to:
adjust one or more of a confidence threshold and a size threshold of objects to be detected for different zones of the individual's body via a user interface for either or both of the first artificial intelligence model and the second artificial intelligence model.

29. The medium of claim 23 wherein the autoencoder is a convolutional autoencoder, a variational autoencoder or an adversarial autoencoder.

30. The medium of claim 23, wherein the autoencoder includes an encoder and decoder that is trained in an unsupervised manner and optimized to reduce reconstruction loss.

31. The medium of claim 30, wherein the encoder compresses the original image into a latent space representation, the decoder reconstructs the image from the latent space representation, and the loss between the original and reconstructed images is backpropagated to adjust the model weights.

32. A non-transitory medium holding computing device-executable instructions for performing threat detection, the instructions when executed causing at least one computing device equipped with a processor to:
receive and process a plurality of digital images taken of an object scanned using an object scanner, the processing using a first artificial intelligence model trained to detect known threats;
process the plurality of digital images using a second artificial intelligence model that is trained to detect anomalies and utilizes an autoencoder;
determine based on the processing performed using both the first artificial intelligence model and the second artificial intelligence model, that the plurality of digital images includes at least one suspect image; and
generate an alert regarding the suspect image.

33. The medium of claim 32, wherein the alert includes an image of the individual with a graphical indicator identifying an area of concern.

34. The medium of claim 32, wherein the instructions when executed further cause the at least one computing device to:
train the second artificial intelligence model in an unsupervised manner on a plurality of normal condition images of individuals having a range of Body Mass Indexes.

35. The medium of claim 25, wherein the instructions when executed further cause the at least one computing device to:
use augmentations added to the normal condition images to train the anomaly detector.

36. The medium of claim 32, wherein the instructions when executed further cause the at least one computing device to:
adjust a confidence threshold for both the first artificial intelligence model and the second artificial intelligence model via a user interface to balance detection rates against false alarm rates.

37. The medium of claim 32, wherein the instructions when executed further cause the at least one computing device to:
adjust a size threshold of objects to be detected via a user interface.

38. The medium of claim 32 wherein the autoencoder is a convolutional autoencoder, a variational autoencoder or an adversarial autoencoder.

39. The medium of claim 32, wherein the autoencoder includes an encoder and decoder that is trained in an unsupervised manner and optimized to reduce reconstruction loss.

40. The medium of claim 39, wherein the encoder compresses the original image into a latent space representation, the decoder reconstructs the image from the latent space representation, and the loss between the original and reconstructed images is backpropagated to adjust the model weights.

41. A system for object threat detection, the system comprising:
a body scanner configured to scan an individual, the scan producing a plurality of digital images;
one or more processors configured to execute instructions to:
process the plurality of digital images using a first artificial intelligence model trained to detect known threats,
process the plurality of digital images using a second artificial intelligence model that is trained to detect anomalies and utilizes an autoencoder,
determine based on the processing performed using both the first artificial intelligence model and the second artificial intelligence model, that the plurality of digital images includes at least one suspect image, and
generate an alert regarding the suspect image; and
a display device configured to display the alert.

42. The system of claim 41 wherein the body scanner is a millimeter wave scanner.

43. A system for object threat detection, the system comprising:
An object scanner configured to scan an object, the scan producing a plurality of digital images;
one or more processors configured to execute instructions to:
process the plurality of digital images using a first artificial intelligence model trained to detect known threats,
process the plurality of digital images using a second artificial intelligence model that is trained to detect anomalies and utilizes an autoencoder,
determine based on the processing performed using both the first artificial intelligence model and the second artificial intelligence model, that the plurality of digital images includes at least one suspect image, and
generate an alert regarding the suspect image; and
a display device configured to display the alert.

44. The system of claim 43 wherein the object scanner is a CT scanner or x-ray scanner.
